(19) United States
(12) Patent Application Publication
(10) Pub. No.: US 2006/0025079 A1
(43) Pub. Date: Feb. 2, 2006

(54) Channel estimation for a wireless communication system

(76) Inventors: Ilan Sutskover, Hadera (IL); David Ben-Eli, Modiin (IL); Uri Perlmutter, Hollon (IL)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/911,159

(22) Filed: Aug. 2, 2004

(51) Int. Cl. H04Q 7/20

(52) U.S. Cl. 455/67.11

(57) ABSTRACT

Method and apparatus to perform channel estimation for a wireless communication system are described.

### BACKGROUND

A wireless communication system may use channel estimation techniques to improve system performance. Channel estimation may refer to measuring or evaluating certain characteristics of communication channel to adapt a transmitted signal to current conditions for the communication channel. Enabling or improving channel estimation may result in enhanced link performance, and thereby potentially provide higher bandwidth per channel, reduced error rates, increased quality, and so forth. Consequently, there may be a need for such improvements in a device or network.

### BRIEF DESCRIPTION OF THE DRAWINGS

FIG. 1 illustrates a block diagram of a system 100.

FIG. 2 illustrates a block diagram of a transmitter/receiver (transceiver) 200.

FIG. 3 illustrates a block diagram of a transceiver 300.

FIG. 4 illustrates an uplink frame 402.

FIG. 5 illustrates a schedule for multiple preambles.

FIG. 6 illustrates a processing logic 600.

FIG. 7 illustrates a processing logic 700.

### DETAILED DESCRIPTION

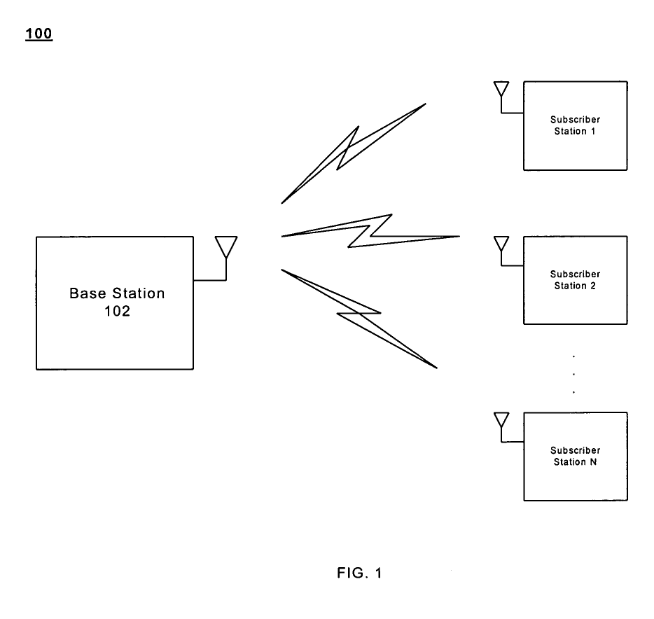

FIG. 1 illustrates a block diagram of a system 100. System 100 may comprise, for example, a communication system having multiple nodes. A node may comprise any physical or logical entity having a unique address in system 100. Examples of a node may include, but are not necessarily limited to, a computer, server, workstation, laptop, ultra-laptop, handheld computer, telephone, cellular telephone, personal digital assistant (PDA), router, switch, bridge, hub, gateway, wireless access point (WAP), and so forth. The unique address may comprise, for example, a network address such as an Internet Protocol (IP) address, a device address such as a Media Access Control (MAC) address, and so forth. The embodiments are not limited in this context.

The nodes of system 100 may be connected by one or more types of communications media and input/output (I/O) adapters. The communications media may comprise any media capable of carrying information signals. Examples of communications media may include metal leads, semiconductor material, twisted-pair wire, co-axial cable, fiber optics, radio frequency (RF) spectrum, and so forth. An information signal may refer to a signal which has been coded with information. The I/O adapters may be arranged to operate with any suitable technique for controlling information signals between nodes using a desired set of communications protocols, services or operating procedures. The I/O adapters may also include the appropriate physical connectors to connect the I/O adapters with a corresponding communications media. Examples of an I/O adapter may include a network interface, a network interface card (NIC), radio/air interface, disc controllers, video controllers, audio controllers, and so forth. The embodiments are not limited in this context.

The nodes of system 100 may be configured to communicate different types of information, such as media information and control information. Media information may refer to any data representing content meant for a user, such as voice information, video information, audio information, text information, alphanumeric symbols, graphics, images, and so forth. Control information may refer to any data representing commands, instructions or control words meant for an automated system. For example, control information may be used to route media information through a system, or instruct a node to process the media information in a predetermined manner.

The nodes of system 100 may communicate media and control information in accordance with one or more protocols. A protocol may comprise a set of predefined rules or instructions to control how the nodes communicate information between each other. The protocol may be defined by one or more protocol standards as promulgated by a standards organization, such as the Internet Engineering Task Force (IETF), International Telecommunications Union (ITU), the Institute of Electrical and Electronics Engineers (IEEE), and so forth. For example, system 100 may operate in accordance with an orthogonal frequency division multiple access (OFDMA) air interface as defined by the IEEE 802.16 family of specifications, such as the Draft IEEE Standard For Local And Metropolitan Area Networks titled “Part 16: Air Interface for Fixed and Mobile Broadband Wireless Access Systems,” 802.16-REVe/D3-2004 dated May 31, 2004, and the Draft IEEE Standard For Local And Metropolitan Area Networks titled “Part 16: Air Interface For Fixed Broadband Wireless Access Systems,” 802.16-REVd/D5-2004 dated May 13, 2004 (collectively referred to herein as “802.16 Specification”).

Referring again to FIG. 1, system 100 may comprise multiple wireless nodes. The wireless nodes may be arranged to communicate information over a wireless communication medium, such as RF spectrum. The wireless nodes may include any of the nodes previously described with additional components and interfaces suitable for communicating information signals over the designated RF spectrum. For example, the wireless nodes may include directional or omni-directional antennas, wireless RF transceivers, amplifiers, filters, control logic, and so forth. Some examples of a wireless node may include a mobile or cellular telephone, a computer equipped with a wireless access card or modem, a handheld client device such as a wireless PDA, a WAP, a base station, a mobile subscriber center, a radio network controller, a subscriber station, and so forth.

In one embodiment, system 100 maybe implemented as an OFDMA system using orthogonal frequency division multiplexing (OFDM). OFDM may comprise a multi-carrier block modulation scheme which is highly efficient since it allows for spectral overlap. OFDM transforms a frequency selective fading channel into multiple narrow flat fading parallel sub-channels. This may increase the symbol duration and mitigate inter-symbol interference (ISI) caused by multipath interference. In one embodiment, system 100 may apply multi-user access by employing OFDMA. For example, system 100 may be arranged to operate in accordance with an OFDMA air interface such as defined by the 802.16 Specification. The embodiments, however, are not limited in this context.

In one embodiment, system 100 may include base station 102 and subscriber stations 1-N. Base station 102 may communicate with subscriber stations 1-N using the OFDMA air interface. Base station 102 may assign one or more channels for use by each subscriber station. Each channel may comprise a two-dimensional data region in the time-frequency domain. For example, each subscriber station 1-N may be assigned different tiles of the RF spectrum to allow simultaneous access to base station 102 in an orthogonal manner. The term “orthogonal” may refer to multiple subscriber stations communicating information without interfering with each other. When base station 102 communicates with a subscriber station 1-N over a channel, the channel may be referred to as a “downlink channel.” When a subscriber station 1-N communicates to base station 102 over a channel, the channel may be referred to as an “uplink channel.”

In one embodiment, base station 102 and/or subscriber stations 1-N maybe arranged to perform channel estimation. For example, during the initialization of system 100, base station 102 and subscriber stations 1-N may go through a training phase in an attempt to characterize one or more communication channels. A channel estimator implemented in base station 102 may control or assist in the training phase. Signals may be communicated from subscriber stations 1-N to base station 102, and at least one characteristic of each channel may be measured, such as channel impulse responses, amplitude levels, shapes of the signals, signal distortion, crosstalk impulse responses, temporal shifts and delays, and so forth. Subscriber stations 1-N may communicate predetermined signals, and deviancies from the expected values are noted by the receiver of base station 102.

In one embodiment, for example, base station 102 and/or subscriber stations 1-N may use a form of time division duplexing (TDD) reciprocity to perform downlink channel estimation. One or more subscriber stations 1-N may communicate known pilot tones in the uplink channel at a power level that may be known to base station 102. This may allow base station 102 to measure or estimate one or more characteristics of the uplink channel, and use the estimates to identify a first set of channel estimate parameters, such as uplink channel coefficients, for example. The uplink channel coefficients may be used infer similar characteristics for the downlink channel, and thereby identify a second set of channel estimate parameters, such as downlink channel coefficients, for example. TDD reciprocity assumes that receive and transmit chains in base station 102 are calibrated up to a certain deterministic mapping.

Conventional TDD reciprocity, however, may be unsatisfactory for a number of reasons. For example, conventional TDD reciprocity typically allows downlink knowledge only within the spectrum boundaries of the uplink data region assigned to each subscriber station. This is a particularly disadvantageous problem for a subscriber station without an active uplink data region mapping, since no updated knowledge is available. Moreover, even with an active uplink data region mapping, conventional TDD reciprocity is disadvantageous since no information of channel conditions outside the uplink data region is known, thus limiting the flexibility of the base station data region assignments. In another example, in modes such as partial usage of subchannels (PUSC) or full usage of subchannels (FUSC) as defined in the 802.16 Specification, the uplink physical spectrum may be using an assignment of subcarriers leading to non equi-spaced sampling, thereby resulting in degraded channel knowledge.

To solve these and other problems, base station 102 and subscriber stations 1-N may be arranged to use new OFDMA uplink preambles. The uplink preambles may contain pilot tones which may be used for channel estimation for the downlink channels assigned by base station 102 to subscriber stations 1-N. In one embodiment, the pilot tones may be embedded within a preamble. A preamble may contain information that typically precedes data information. Although the embodiments may be discussed in terms of a “preamble” by way of example, however, it may be appreciated that the pilot tones embedded within the preamble may be sent anywhere within an uplink frame in the OFDMA system, to include before data information (e.g., preamble), between data information (e.g., midamble), and after data information. The embodiments are not limited in this context.

In one embodiment, the uplink preambles may be designed to operate with an OFDMA system. For example, the uplink preambles may be specifically designed to operate with the OFDMA air interface as defined by the 802.16 Specification. The embodiments are not limited in this context.

The use of uplink preambles for channel estimation may provide several advantages. For example, the uplink preambles may be designed to use pilot tones that cover all or part of the RF spectrum allocated to base station 102. In this manner, base station 102 may use this information to intelligently assign the available RF spectrum to enhance overall system performance. The uplink preambles may be sent by a single subscriber station, or multiple subscriber stations using different data regions. The transmission of the new uplink preambles may also be made periodic to compensate for the time-varying characteristics of a channel. The preambles may be sent independently of existence of an uplink transmission. In addition, they may primarily serve to train base station 102 for downlink operations.

Since base station 102 is made aware of the channel conditions across the entire spectrum allocated to base station 102 via the uplink preambles sent by subscriber stations 1-N, base station 102 can dynamically assign or schedule frequency bins to different subscriber stations 1-N by matching a subscriber station to the appropriate channel conditions. This may increase total throughput provided by base station 102. Enhancements of scheduling may also yield a further increase of the total throughput.

In one embodiment, the total throughput for base station 102 may be further increased through spatial diversity. Base station 102 may use multiple antennas for beam-forming with antenna weights that are based on the channel estimator. For example, a zero forcing beam-forming technique may be used. Zero forcing beam-forming may invert the channel response of the channel, so that each subscriber station sees only the signal assigned to it and not signals assigned to other subscriber stations. This may also allow use of spatial division multiple access (SDMA) transmission, so that several subscriber stations can be transmitted to simultaneously over the same time and frequency using, for example, the zero forcing beam-forming technique. The embodiments are not limited in this context.

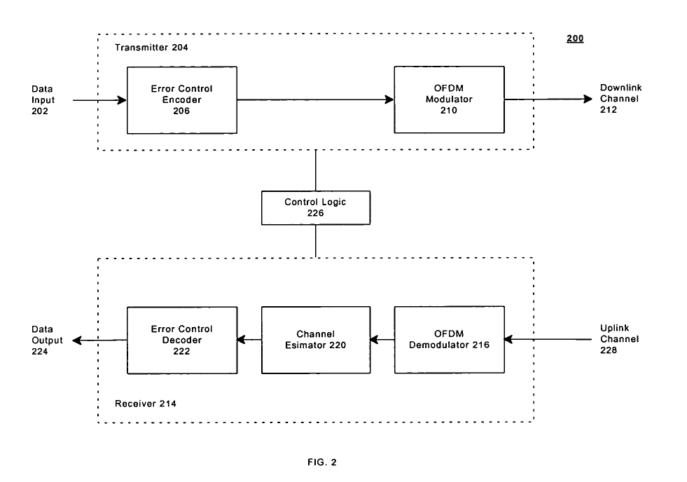

FIG. 2 illustrates a block diagram of a transceiver 200. Transceiver 200 may illustrate a transceiver for use with one or more nodes of system 100, such as base station 102. As shown in FIG. 2, transceiver 200 may comprise multiple elements, such as a transmitter 204, a receiver 214, and control logic 226. Some elements may be implemented using, for example, one or more circuits, components, registers, processors, software subroutines, or any combination thereof. Although FIG. 2 shows a limited number of elements, it can be appreciated that more or less elements may be used in transceiver 200 as desired for a given implementation. The embodiments are not limited in this context.

In one embodiment, transceiver 200 may comprise transmitter 204. Transmitter 204 may comprise, for example, an error control encoder 206 and an OFDMA modulator 210. Error control encoder 206 may receive a data input signal 202 and encode the data signal in accordance with an error correction technique, such as forward error correction (FEC), for example. OFDMA modulator 210 may convert the data signals to OFDMA signals using OFDMA techniques. For example, OFDMA modulator 210 may map the data signals to OFDMA symbols using a modulation technique, such as biphase shift keying (BPSK), quadrature phase shift keying (QPSK), 16 quadrature amplitude modulation (QAM), 64-QAM, 256-QAM, and so forth. The mapped symbols may be modulated onto several orthogonal subcarriers. The resulting streams may be converted from frequency domain signals to time domain signals using inverted discrete fourier transform (IDFT). A guard interval including a cyclic prefix, for example, may be inserted in front of the transmitted symbol to reduce ISI. The OFDMA signals may then be transmitted over downlink channel 212 to a receiver, such as a receiver for one of subscriber stations 1-N.

In one embodiment, transceiver 200 may comprise receiver 214. Receiver 214 may comprise, for example, an OFDMA demodulator 216, a channel estimator 220, and an error control decoder 222. Receiver 214 may receive OFDMA signals over uplink channel 228 from a transmitter, such as a transmitter for one of subscriber stations 1-N. OFDMA demodulator 216 may reverse the operations of OFDMA modulator 210. For example, the guard interval may be removed from the received symbols, and the symbols may be transformed from the time domain to the frequency domain by discrete fourier transform (DFT). The frequency domain signals may be equalized by channel estimator 220. Channel estimator may perform channel estimation as described in more detail below. Error control decoder 222 may then perform error correction on the signal to recover any data remaining in the signal. The error corrected signals may form a data output signal 224.

In one embodiment, transceiver 200 may comprise control logic 226. Control logic 226 may be connected to transmitter 204 and receiver 214. Control logic 226 may provide control signals to transmitter 204 and receiver 214 to facilitate OFDMA operations in a base station, such as base station 102.

In general operation, receiver 214 may periodically receive a preamble having a set of pilot tones corresponding to a set of frequency bands over uplink channel 228 communicated in accordance with an OFDMA air interface. Channel estimator 220 of receiver 214 may receive the pilot tones and estimate a first set of channel estimate parameters for the frequency bands using the pilot tones. Channel estimator 220 may translate the first set of channel estimate parameters to a second set of channel estimate parameters, and provide the second set of channel estimate parameters as output. Control logic 226 may receive the second set of channel estimate parameters, and assign the first set of frequency bands to multiple subscriber stations in accordance with the second channel estimate parameters.

It is worthy to note that the error correction code is not necessarily operational in this particular set of operations. The embodiments, however, are not limited in this context.

In one embodiment, the first set of frequency bands may comprise multiple frequency bands available to base station 102 for assignment to subscriber stations 1-N. For example, the first set of frequency bands may include a complete set of frequency bands available to base station 102 for assignment to subscriber stations 1-N. In another example, the first set of frequency bands may include a subset of a complete set of frequency bands available to base station 102 for assignment to subscriber stations 1-N. In yet another example, the subset may include at least two frequency bands of the complete set of frequency bands available to base station 102 for assignment to subscriber stations 1-N. The embodiments are not limited in this context.

In one embodiment, receiver 214 of base station 102 may be arranged to receive one or more preambles from one or more subscriber stations 1-N. For example, receiver 214 may be arranged to receive a preamble from a single subscriber station. In another example, receiver 214 may be arranged to receive multiple preambles from multiple subscriber stations. In yet another example, receiver 214 may be arranged to receive multiple preambles from a single subscriber station. The embodiments are not limited in this context.

In one embodiment, each preamble may include one or more sets of pilot tones. For example, each preamble may use a different set of pilot tones. The pilot tones may be for a same set of frequency bands, or for different sets of frequency bands. The embodiments are not limited in this context.

In one embodiment, transmitter 204 may be connected to control logic 226. Control logic 226 may generate a control message, and send the control message to one or more subscriber stations 1-N over downlink channel 212 via transmitter 204. The control message may include an information element to instruct a subscriber station 1-N to send a preamble on a periodic basis. The information element may include an identifier for a subscriber station, an identifier for a transmit antenna of a subscriber station, a set of pilot tones, and a data region for a response message. More particularly, the information element may include an extended uplink interval usage code, a connection identifier, an antenna identifier, a preamble location, a symbol number, a pilot set number, a preamble period, a pilot transmission power scheme, and a response message allocation, for example. An example of an information element for the control message may be illustrated in Table 1 as follows:

TABLE 1

| Syntax | Size | Notes |
|---|---|---|
| UL_CSIT_REQ_IE { | | |
| Extended UIUC | 4 bits | |
| CID | 16 bits | |
| Preambles location | 1 bit | 0b0 = Preambles are counted from the beginning |
| | | of the uplink subframe and forward. |
| | | 0b1 = Preambles are counted from the end of the |
| | | uplink subframe and backward. |
| OFDMA symbol number | 3 bit | Location of the OFDMA symbol inside the region |
| | | used for uplink preambles. |
| | | 0b000 = first symbol ... 0b111 = eighth symbol. |
| Pilot set number | 4 bits | The value of k in Equation (1) below. |
| Preamble period | 2 bits | 0b00 = Single transmission, not periodic. |
| | | 0b01 = once per frame. |
| | | 0b10 = once per 2 frames. |
| | | 0b11 = once per 4 frames. |
| Subscriber Station Antenna Number | 2 bits | Up to 4 antennas may be supported at the |
| | | subscriber station. |
| Pilot transmission power scheme | 3 bits | Reserved |
| Response message allocation { | | From Table 285 of 802.16 Specification |
| Duration | 10 bits | |
| Repetition coding indication | 2 bits | |
| } | | |
| } | | |
| Total: | 47 bits | |

Base station 102 may instruct a subscriber station to start transmitting preambles by an information element embedded in the UL-MAP as defined in the 802.16 Specification. This information element may include the identity of the subscriber station, the pilot set and a data region used for a response message. To accomplish this, base station 102 may transmit in the UL-MAP UIUC=15 with the above-defined UL_CSIT_REQ_IE( ) message to indicate a request for uplink preambles from a subscriber station. In another example, a MAC message may be sent instead of the information element in the UL-MAP. The MAC message may include, for example, the fields of management message type, a connection identifier, an antenna identifier, a preamble location, a symbol number, a pilot set number, a preamble period, a pilot transmission power scheme, and a response message allocation.

One or more subscriber stations may send uplink preambles with pilot tones covering all or part of the RF spectrum allocated to base station 102. Once channel estimate parameters have been estimated for the entire RF spectrum, control logic 226 may assign certain data regions to certain subscriber stations in a manner that optimizes use of the allocated RF spectrum. For example, control logic 226 may assign spectrum to certain subscriber stations based on a number of factors, such as priority levels assigned to each subscriber station, bandwidth demands for each subscriber station, fading conditions of the channel, types of information communicated by each subscriber station, and so forth. By intelligently assigning the RF spectrum allocated to base station 102, overall performance of system 100 may be improved. In addition, certain optimized transmission techniques such as coherent transmit beamforming may also be implemented to further increase performance of system 100. As a result, system 100 may have increased total data throughput by increasing spectral efficiency through the advanced use of multi-user diversity.

Prior to sending a control message, base station 102 may attempt to determine whether a given subscriber station supports the use of uplink preambles to perform channel estimation. A subscriber station arranged to send uplink preambles may be referred to herein as a “Channel State Information at the Transmitter” or CSIT enabled subscriber station. A CSIT enabled subscriber station may send a capability message to base station 102 during initialization or upon request by base station 102. An example of a capability message format may be shown in Table 2 as follows:

TABLE 2

| Type | Length | Value | Scope |
|---|---|---|---|
| 155 | 1 bit | Bit #0: CSIT capability | SBC-REQ (see 6.3.2.3.23 of |
| | | | 802.16 Specification) |
| | | Bits #1-7: reserved. | SBC-RSP (see 6.3.2.3.24 of |
| | | | 802.16 Specification) |

The capability message may include a field to indicate whether a subscriber station is capable of supporting CSIT (e.g., uplink preambles). A bit value of zero (0) may indicate “not supported” while a bit value of one (1) may indicate “supported”. The capability message may be sent as a separate message or may be embedded within another message, such as the SBC-REQ and SBC-RSP messages as defined by the 802.16 Specification. The embodiments are not limited in this context.

Alternatively, there may exist a case where subscriber stations 1-N are not capable of responding to the capability message, either due to their configuration or lack of awareness of the CSIT capability. In this case, a subscriber station 1-N may send a capability message indicating all of its capabilities. Base station 102 may receive the capability message, and determine whether it includes a value indicating CSIT capability. The embodiments are not limited in this context.

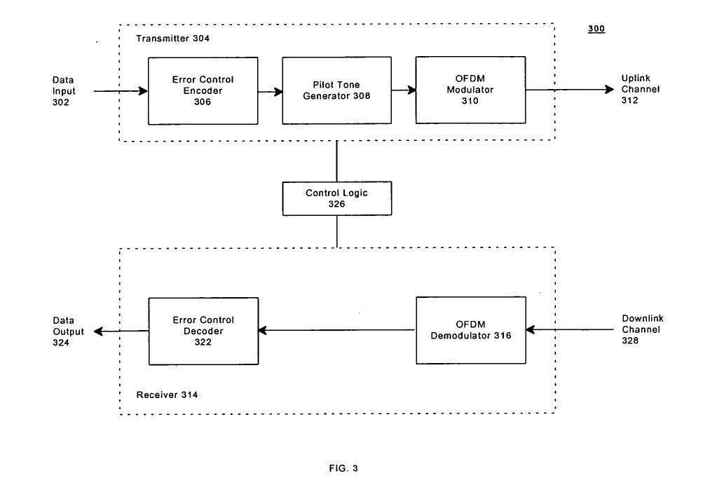

FIG. 3 illustrates a block diagram of a transceiver 300. Transceiver 300 may illustrate a transceiver for use with one or more nodes of system 100, such as subscriber stations 1-N. As shown in FIG. 3, transceiver 300 may comprise multiple elements, such as a transmitter 304, a receiver 314, and control logic 326. Some elements may be implemented using, for example, one or more circuits, components, registers, processors, software subroutines, or any combination thereof. Although FIG. 3 shows a limited number of elements, it can be appreciated that more or less elements may be used in transceiver 300 as desired for a given implementation. The embodiments are not limited in this context.

In one embodiment, transceiver 300 may include a transmitter 304. Transmitter 304 may include an error control encoder 306, a pilot tone generator 308, and an OFDMA modulator 310. Error control encoder 306 and OFDMA modulator 310 may be similar to error control encoder 206 and OFDMA modulator 210 as described with reference to FIG. 2. Transmitter 304 may receive as input data input signal 302 and one or more messages from control logic 326, and output OFDMA signals encoded with information from data input signal 302 and/or the messages from control logic 326. The OFDMA signals may then be transmitted over uplink channel 312 to a receiver, such as a receiver for base station 102.

In one embodiment, transmitter 304 may include pilot tone generator 308. Pilot tone generator 308 may be used to insert one or more pilot tones over one or more frequency bands into the OFDMA signals in accordance with a given uplink preamble. In one embodiment, for example, a total of 16 pilot sets may be defined per a single OFDMA symbol. The pilots associated with the k-th set may be given by the subcarriers whose location is determined according to Equation (1) as follows:
(p(BaseID,FrameNumber)+k)mod16+16m for m=0,1, . . . (1)
The parameter k may be used to distinguish among pilot sets, while p(BaseID, FrameNumber) is the value in PermutationBase as defined in the 802.16 Specification by Table 309 titled “OFDMA downlink carrier allocations” at the location BaseID+FrameNumber. This permutation may assist in mitigating consistent inter-cell interference. In one embodiment, the pilots in each set may cover the entire data region allocated to base station 102, or a subset of the entire data region allocated to base station 102. The pilots may be prohibited from overlapping with reserved zones that might exist in this symbol, such as for a contention-based ranging zone, for example. In such cases, the overlapping pilot subcarriers may be zeroed.

It is worthy to note that although pilot tone generator 308 may be illustrated in FIG. 3 as separate from OFDMA modulator 310, it may be appreciated that pilot tone generator 308 may be integrated with OFDMA modulator 310 and still fall within the scope of the embodiments. The embodiments are not limited in this context.

In one embodiment, transceiver 300 may comprise receiver 314. Receiver 314 may comprise, for example, an OFDMA demodulator 316 and an error control decoder 322. Receiver 314 may receive OFDMA signals over downlink channel 328 from a transmitter, such as a transmitter for base station 102. OFDMA demodulator 316 and error control decoder 322 may be similar to OFDMA demodulator 216 and error control decoder 222 as described with reference to FIG. 3.

In one embodiment, transceiver 300 may comprise control logic 326. Control logic 326 may be connected to transmitter 302 and receiver 314. As with control logic 226, control logic 326 may provide control signals to transmitter 302 and receiver 314 to facilitate OFDMA operations in a subscriber station, such as subscriber stations 1-N.

In general operation, transceiver 300 may send one or more uplink preambles at predetermined time intervals or in response to an external event. The predetermined time intervals may be established by a user, base station 102, or as default parameters during manufacture of the subscriber station. In this case, any subscriber station within system 100 may send an uplink preamble, even those subscriber stations that have not yet been assigned a data region by base station 102 in a previous downlink transmission. Examples of an external event may comprise a signal to indicate a subscriber station is to perform initializing operations during power-up or start-up of a subscriber station, during a restart of a subscriber station, an explicit request received from a user, an explicit request received from base station 102, and so forth. The embodiments are not limited in this context.

In one embodiment, for example, receiver 314 may receive a control message from base station 102 to send an uplink preamble having a set of pilot tones corresponding to multiple frequency bands. Control logic 326 may generate a response message to respond to the control message. The response message may be sent over uplink channel 312 to base station 102. Pilot tone generator 308 may generate a set of pilot tones for multiple frequency bands. The pilot tones may be sent over uplink channel 312 to base station 102 as part of the uplink preamble.

In one embodiment, the control message may include an information element to indicate that the preamble is to be sent on a periodic basis. Control logic 326 may send the preamble on a periodic basis in accordance with the parameters given by the control message via transmitter 304.

In one embodiment, the response message may be sent to base station 102 over uplink channel 312. The response message may include the several parameters, such as a management message type, a symbol number, a pilot set number, a preamble period, a subscriber station antenna number, a subcarrier index, and a subcarrier signal-to-interference-plus-noise ratio, for example. An example of the response message format may be illustrated in Table 3 as follows:

TABLE 3

| Syntax | Size | Notes |
|---|---|---|
| CSIT-RSP( ) { | | |
| Management Message Type=50 | 8 bits | |
| OFDMA symbol number | 1 bit | |
| Pilot set number | 4 bits | |
| Preamble period | 2 bits | |
| Subscriber Station Antenna Number | 2 bits | |
| Subcarrier index | 7 bits | |
| Subcarrier SINR | 8 bits | In a similar format |
| | | as defined by |
| | | Section 8.4.10.3 |
| | | of the 802.16 |
| | | Specification, |
| | | for example. |
| } | | |
| Total: | 32 bits | |

The fields OFDMA_symbol_number, Pilot_set_number and Preamble_period may contain the contents of the corresponding UL_CSIT_REQ_IE( ) command, which may constitute the control message sent by base station 102. The field Subcarrier_SINR may provide the signal-to-interference-plus-noise ratio (SINR) measured at the downlink at the location indicated by the field Subcarrier_index, which may be associated with the parameter m in Equation (1) described previously. The SINR may be measured by the subscriber station over a non-beamformed downlink preamble, for example. The embodiments are not limited in this context.

In one embodiment, a subscriber station may also send an unsolicited CSIT_RSP message corresponding to an existing periodic preamble. This may be desirable to provide base station 102 with a new value for the field Subcarrier_SINR, for example.

In one embodiment, base station 102 may need to terminate a periodic uplink preamble or multiple preambles from subscriber stations 1-N. This may be accomplished using a termination message (e.g., CSIT_BS_TRM) having a format as shown in Table 4 as follows:

TABLE 4

| Syntax | Size | Notes |
|---|---|---|
| CSIT-BS-TRM( ) { | | |
| Management Message Type=51 | 8 bits | |
| OFDMA symbol number | 1 bit | |
| Pilot set number | 4 bits | |
| Preamble period | 2 bits | |
| Subscriber Station Antenna Number | 2 bits | |
| Terminate all preambles | 1 bit | 0b0 = Terminate all pilot |
| | | sets of this mobile. |
| | | 0b1 = Terminate |
| | | specified set alone. |
| } | | |
| Total: | 18 bits | |

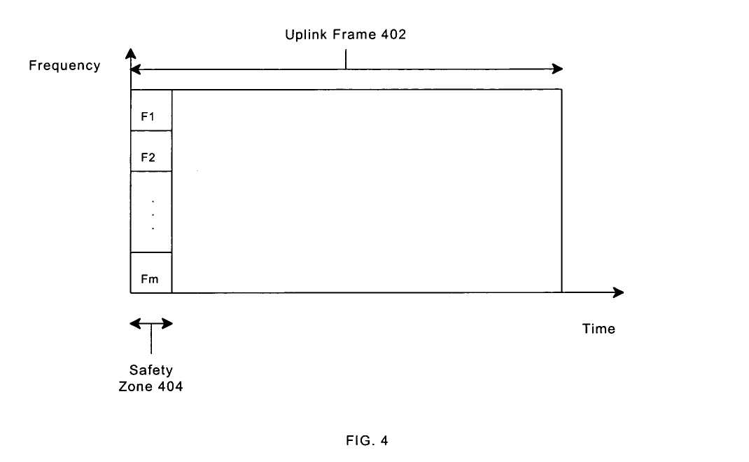

FIG. 4 illustrates an uplink frame 402 for OFDMA signals transmitted by transmitter 304 of a subscriber station 1-N. Multiple subscriber stations 1-N may send an uplink preamble to base station 102 over uplink channel 312 using an uplink frame, such as uplink frame 402. Base station 102 may allocate a number of OFDMA symbols over which uplink preambles are transmitted by subscriber stations 1-N. The uplink preambles may be sent at any OFDMA symbol interval desired for a given implementation. In one embodiment, for example, the uplink preamble may be sent using a single OFDMA symbol interval, although the embodiments are not limited in this context. In any event, the uplink preamble should be sent in a manner to reduce interference with communications by other nodes within range of the transmitting subscriber station or receiving base station. Accordingly, base station 102 may attempt to protect the uplink preambles from interference by other subscriber stations within transmitting range by defining a symbol interval of uplink frame 402 as a safety zone, such as safety zone 404. As shown in FIG. 4, safety zone 404 may comprise one or more symbol intervals for a range of frequency bands F1-FM. Safety zone 404 is shown at the beginning of uplink frame 402 only by way of example, and the embodiments are not limited in this context. A subscriber station 1-N instructed by base station 102 to transmit a preamble over safety zone 404 may do so while ignoring the safety zone command from base station 102.

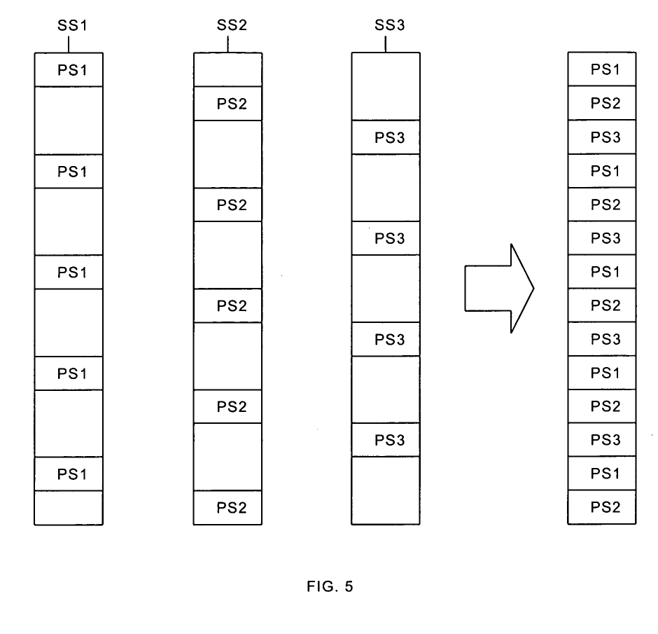

FIG. 5 illustrates a schedule for multiple preambles. As stated previously, receiver 214 of base station 102 may be arranged to receive one or more preambles from one or more subscriber stations 1-N. For example, receiver 214 may be arranged to receive a preamble from a single subscriber station, or multiple preambles from multiple subscriber stations. In the latter case, multiple subscriber stations may be instructed to send preambles using different data regions.

To be able to discriminate between subscriber stations, each subscriber station may receive one or more unique pilot sets. As shown in FIG. 5, a first subscriber station (SS1) may be assigned a first pilot set (PS1). A second subscriber station (SS2) may be assigned a second pilot set (PS2). A third subscriber station (SS3) may be assigned a third pilot set (PS3). The pilot sets may be allocated to different subcarriers and equally spaced. The cyclic shift may depend upon the base identifier. The preamble symbol may be defined a safety zone, such as safety zone 404, for example. Power of the transmitted pilot may vary according to a given implementation. All subcarriers assigned to a pilot set may be modulated by BPSK symbols as defined by, for example, the 802.16 Specification.

It is worthy to note that a single subscriber station may receive two or more unique pilot sets. The assignment of more than one pilot set to the same subscriber station may be useful in reducing large delay spreads, for example. The embodiments are not limited in this context.

It is also worthy to note that a single subscriber station may use multiple antennas. In such cases, one or more pilot sets may be assigned to each antenna of the subscriber station. The use of multiple antennas may improve communication between subscriber stations 1-N and base station 102 by allowing spatial diversity. The embodiments are not limited in this context.

Operations for the system 100 and transceiver 200 and 300 may be further described with reference to the following figures and accompanying examples. Some of the figures may include programming logic. Although such figures presented herein may include a particular programming logic, it can be appreciated that the programming logic merely provides an example of how the general functionality described herein can be implemented. Further, the given programming logic does not necessarily have to be executed in the order presented unless otherwise indicated. In addition, the given programming logic may be implemented by a hardware element, a software element executed by a processor, or any combination thereof. The embodiments are not limited in this context.

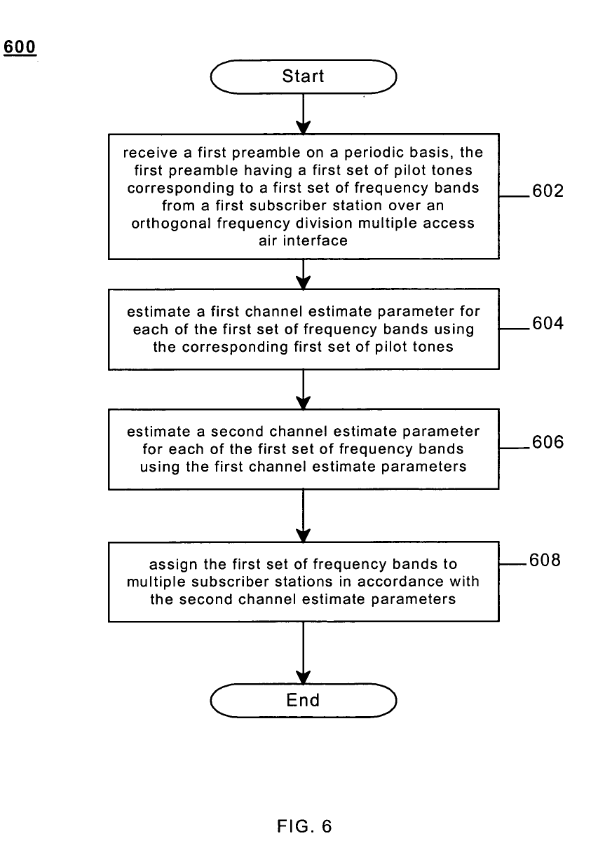

FIG. 6 illustrates a programming logic 600. Programming logic 600 may be representative of the operations executed by one or more systems described herein, such as base station 102. As shown in programming logic 600, a first preamble may be received on a periodic basis, with the first preamble having a first set of pilot tones corresponding to a first set of frequency bands from a first subscriber station over an orthogonal frequency division multiple access air interface at block 602. The first preamble may comprise, for example, an uplink preamble designed to be interoperable with the 802.16 Specification. A first channel estimate parameter for each of the first set of frequency bands may be estimated using the corresponding first set of pilot tones at block 604. A second channel estimate parameter for each of the first set of frequency bands may be estimated using the first channel estimate parameters at block 606. A first set of frequency bands may be assigned to multiple subscriber stations in accordance with the second channel estimate parameters at block 608.

In one embodiment, a second preamble having a second set of pilot tones corresponding to a second set of frequency bands from a second subscriber station may be received. The second preamble may comprise, for example, an uplink preamble designed to be interoperable with the 802.16 Specification. A third channel estimate parameter for each of the second set of frequency bands may be estimated using the corresponding second set of pilot tones. A fourth channel estimate parameter for each of the second set of frequency bands may be estimated using the third channel estimate parameters. The second set of frequency bands may be assigned to multiple subscriber stations in accordance with the fourth channel estimate parameters.

In one embodiment, the first preamble and said second preamble may be communicated at the same time although using different frequency bands. For example, a case may arise where the second preamble may arrive at base station 102 at the same time as the first preamble. The pilot sets for each preamble, however, may be disjoint so that base station 102 may address both pilot sets and perform channel estimation for both subscriber stations. Alternatively, the first preamble and second preamble may be communicated using the same frequency bands but at different time intervals. The embodiments are not limited in this context.

In one embodiment, the first set of pilot tones may be the same as the second set of pilot tones. Alternatively, the first set of pilot tones may be different from the second set of pilot tones. The embodiments are not limited in this context.

In one embodiment, the first set of frequency bands may be different from the second set of frequency bands. In another embodiment, the first set of frequency bands and the second set of frequency bands may be similar or identical. In yet another embodiment, the second set of frequency bands may comprise a subset of the first set of frequency bands.

In one embodiment, a second preamble having a third set of pilot tones corresponding to a second set of frequency bands from the second subscriber station may be received. A fifth channel estimate parameter for each of the second set of frequency bands may be estimated using the corresponding third set of pilot tones. A sixth channel estimate parameter for each of the second set of frequency bands may be estimated using the fifth channel estimate parameters. The second set of frequency bands may be assigned to multiple subscriber stations in accordance with the sixth channel estimate parameters.

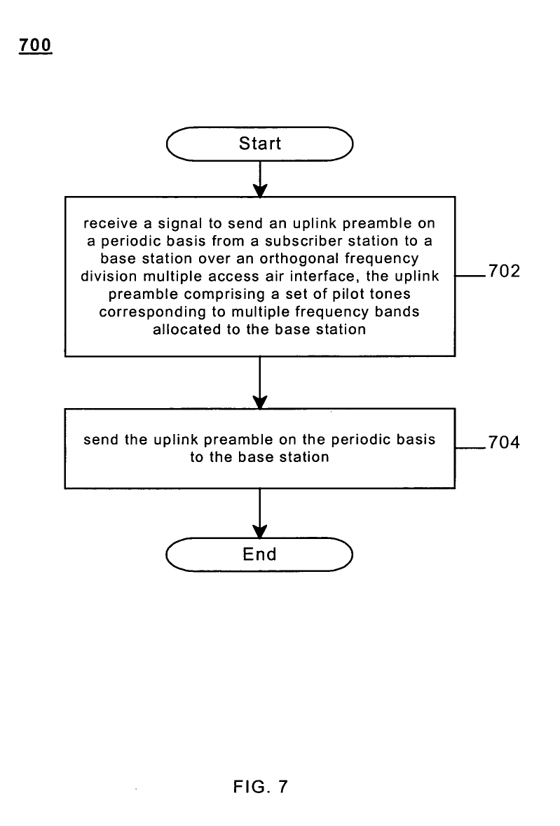

FIG. 7 illustrates a programming logic 700. Programming logic 700 may be representative of the operations executed by one or more systems described herein, such as subscriber stations 1-N. As shown in programming logic 700, a signal to send an uplink preamble on a periodic basis from a subscriber station to a base station over an orthogonal frequency division multiple access air interface may be received at block 702. The uplink preamble may comprise a set of pilot tones corresponding to multiple frequency bands allocated to the base station. The uplink preamble may be sent on the periodic basis to the base station at block 704.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

It is also worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some embodiments may be implemented using an architecture that may vary in accordance with any number of factors, such as desired computational rate, power levels, heat tolerances, processing cycle budget, input data rates, output data rates, memory resources, data bus speeds and other performance constraints. For example, an embodiment may be implemented using software executed by a general-purpose or special-purpose processor. In another example, an embodiment may be implemented as dedicated hardware, such as a circuit, an application specific integrated circuit (ASIC), Programmable Logic Device (PLD) or digital signal processor (DSP), and so forth. In yet another example, an embodiment may be implemented by any combination of programmed general-purpose computer components and custom hardware components. The embodiments are not limited in this context.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Some embodiments and claims may be described using terms such as “first,” “second,” “third,” “fourth,” and so forth. It may be appreciated that these and similar terms are not necessarily limited to a single device or element. Rather, these terms may be used to differentiate between different elements, and may apply to different devices or elements in different embodiments. The embodiments are not limited in this context.

While certain features of the embodiments have been illustrated as described herein, many modifications, substitutions, changes and equivalents will now occur to those skilled in the art. It is therefore to be understood that the appended claims are intended to cover all such modifications and changes as fall within the true spirit of the embodiments.

1. A method, comprising:
receiving a first preamble on a periodic basis, said first preamble having a first set of pilot tones corresponding to a first set of frequency bands from a first subscriber station over an orthogonal frequency division multiple access air interface;
estimating a first channel estimate parameter for each of said first set of frequency bands using said corresponding first set of pilot tones;
estimating a second channel estimate parameter for each of said first set of frequency bands using said first channel estimate parameters; and
assigning said first set of frequency bands to multiple subscriber stations in accordance with said second channel estimate parameters.

2. The method of claim 1, wherein said first preamble is an orthogonal frequency division multiple access preamble designed to interoperate with an 802.16 Specification.

3. The method of claim 1, wherein said first set of frequency bands have not been previously allocated to said first subscriber station for a downlink channel.

4. The method of claim 1, wherein said first set of frequency bands comprises a complete set of frequency bands allocated to an orthogonal frequency division multiple access system.

5. The method of claim 1, further comprising sending a control message to said first subscriber station to initiate sending said first preamble.

6. The method of claim 5, wherein said control message includes an identifier for said first subscriber station, an identifier for a transmit antenna of a subscriber station, said first set of pilot tones, and a data region for a response message.

7. The method of claim 5, wherein said control message includes an extended uplink interval usage code, a connection identifier, an antenna identifier, a preamble location, a symbol number, a pilot set number, a preamble period, a pilot transmission power scheme, and a response message allocation.

8. The method of claim 7, wherein said preamble location corresponds to a safety zone for a communication frame to reduce interference for said first preamble.

9. The method of claim 1, further comprising:
receiving a second preamble having a second set of pilot tones corresponding to a second set of frequency bands from a second subscriber station;
estimating a third channel estimate parameter for each of said second set of frequency bands using said corresponding second set of pilot tones;
estimating a fourth channel estimate parameter for each of said second set of frequency bands using said third channel estimate parameters; and
assigning said second set of frequency bands to multiple subscriber stations in accordance with said fourth channel estimate parameters.

10. The method of claim 9, wherein said first preamble and said second preamble are communicated using different frequency bands.

11. The method of claim 9, wherein said first preamble and said second preamble are communicated using different time intervals.

12. The method of claim 9, wherein said first set of pilot tones are different from said second set of pilot tones.

13. The method of claim 9, wherein said first set of frequency bands are different from said second set of frequency bands.

14. The method of claim 9, wherein said first set of frequency bands and said second set of frequency bands are identical.

15. The method of claim 9, wherein said second set of frequency bands comprise a subset of said first set of frequency bands.

16. The method of claim 9, further comprising:
receiving said second preamble having a third set of pilot tones corresponding to a second set of frequency bands from said second subscriber station;
estimating a fifth channel estimate parameter for each of said second set of frequency bands using said corresponding third set of pilot tones;
estimating a sixth channel estimate parameter for each of said second set of frequency bands using said fifth channel estimate parameters; and
assigning said second set of frequency bands to multiple subscriber stations in accordance with said sixth channel estimate parameters.

17. A method, comprising:
receiving a signal to send an uplink preamble on a periodic basis from a subscriber station to a base station over an orthogonal frequency division multiple access air interface, said uplink preamble comprising a set of pilot tones corresponding to multiple frequency bands allocated to said base station; and
sending said uplink preamble on said periodic basis to said base station.

18. The method of claim 17, wherein said signal is generated in response to a control message, said control message to include an information element to indicate said preamble is to be sent on a periodic basis.

19. The method of claim 17, wherein said signal is generated by control logic located at said subscriber station.

20. The method of claim 17, wherein said response message includes a management message type, a symbol number, a pilot set number, a preamble period, an antenna identifier, a subcarrier index, and a subcarrier signal-to-interference-plus-noise ratio.

21. The method of claim 17, wherein said uplink preamble is designed to interoperate with an 802.16 Specification.

22. The method of claim 17, further comprising sending a capability message to a base station prior to said response message to indicate whether said preamble may be sent.

23. A base station, comprising:
a receiver to receive a preamble on a periodic basis, said preamble having a set of pilot tones corresponding to a set of frequency bands communicated in accordance with an orthogonal frequency division multiple access air interface, said receiver to include a channel estimator to receive said pilot tones and estimate a first set of channel estimate parameters for said frequency bands using said pilot tones, translate said first set of channel estimate parameters to a second set of channel estimate parameters, and output said second set of channel estimate parameters; and
control logic to connect to said receiver, said control logic to receive said second set of channel estimate parameters and assign said first set of frequency bands to multiple subscriber stations in accordance with said second channel estimate parameters.

24. The base station of claim 23, wherein said first set of frequency bands includes a complete set of frequency bands available for assignment.

25. The base station of claim 23, wherein said first set of frequency bands includes a subset of a complete set of frequency bands available for assignment.

26. The base station of claim 23, wherein said subset includes at least two frequency bands of said complete set of frequency bands available for assignment.

27. The base station of claim 23, wherein said receiver is arranged to receive said preamble from a single subscriber station.

28. The base station of claim 23, wherein said receiver is arranged to receive multiple preambles from multiple subscriber stations.

29. The base station of claim 28, wherein each preamble uses a different set of pilot tones.

30. The base station of claim 28, wherein each set of pilot tones are for a same set of frequency bands.

31. The base station of claim 28, wherein each set of pilot tones are for different sets of frequency bands.

32. The base station of claim 23, further comprising a transmitter to connect to said control logic, said transmitter to transmit a control message from said control logic, said control message to instruct a subscriber station to send said preamble on a periodic basis.

33. The base station of claim 32, wherein said control message includes an identifier for said subscriber station, an identifier for a subscriber station antenna, said set of pilot tones, and a data region for a response message.

34. The base station of claim 32, wherein said control message includes an extended uplink interval usage code, a connection identifier, an antenna identifier, a preamble location, a symbol number, a pilot set number, a preamble period, a pilot transmission power scheme, and a response message allocation.

35. The base station of claim 23, wherein said orthogonal frequency division multiple access air interface is defined by an 802.16 Specification.

36. The base station of claim 23, further comprising an antenna to connect to said receiver and said transmitter.

37. The base station of claim 23, further comprising multiple antennas to connect to said receiver and said transmitter, said multiple antennas to be used for beam-forming with antenna weights that are based on said second set of channel estimate parameters.

38. The base station of claim 37, wherein said beam-forming is performed in accordance with a zero forcing beam-forming technique, which inverts a channel response for each channel, so that each subscriber station sees only a signal assigned to it and not signals assigned to other subscriber stations.

39. The base station of claim 38, wherein said transmitter and receiver are arranged to use spatial division multiple access transmission so that said multiple subscriber stations can be transmitted to simultaneously over a same time and frequency using said zero forcing beam-forming technique.

40. A subscriber station, comprising:
a transceiver to operate in accordance with an orthogonal frequency division multiple access air interface, said transceiver to transmit an uplink preamble in a periodic manner over an uplink channel to a base station.

41. The subscriber station of claim 40, wherein said uplink preamble comprises multiple pilot tones to cover an entire radio-frequency spectrum allocated to said base station, with each pilot tone to be transmitted over a different subcarrier of said radio-frequency spectrum.

42. The subscriber station of claim 40, wherein said transceiver is arranged to perform time division duplexing.

43. The subscriber station of claim 40, wherein said transceiver is arranged to begin transmitting said uplink preamble in response to a control message received from said base station.

44. The subscriber station of claim 40, wherein said transceiver transmits said uplink preamble independent from other uplink traffic transmitted by said transceiver.

45. The subscriber station of claim 40, wherein said transceiver is arranged to transmit a response message prior to transmitting said uplink preamble.

46. The subscriber station of claim 45, wherein said response message includes a management message type, a symbol number, a pilot set number, a preamble period, an antenna number, a subcarrier index, and a subcarrier signal-to-interference-plus-noise ratio.

47. The subscriber station of claim 40, wherein said transceiver is arranged to transmit a capability message in response to said control message.

48. The subscriber station of claim 40, wherein said transceiver stops transmitting said uplink preamble in response to a termination message received from said base station.

49. The subscriber station of claim 40, wherein said orthogonal frequency division multiple access air interface is defined by an 802.16 Specification.

50. A system, comprising:
a base station having a transceiver arranged to operate in accordance with an orthogonal frequency division multiple access air interface, said base station to send a control message to instruct a subscriber station to periodically send a preamble having a set of pilot tones corresponding to a set of frequency bands; and
a first subscriber station having a transceiver arranged to operate in accordance with said orthogonal frequency division multiple access air interface, said first subscriber station to receive said control message and send a response message to said base station in response to said control message, said first subscriber station to periodically send a preamble with said set pilot tones corresponding to said set of frequency bands.

51. The system of claim 50, wherein said base station comprises:
a receiver to receive said set of pilot tones, said receiver to include a channel estimator to estimate a first set of channel estimate parameters for said frequency bands using said pilot tones, translate said first set of channel estimate parameters to a second set of channel estimate parameters, and output said second set of channel estimate parameters; and
control logic to connect to said receiver, said control logic to receive said second set of channel estimate parameters and assign said first set of frequency bands to multiple subscriber stations in accordance with said second channel estimate parameters.

52. The system of claim 50, wherein said first subscriber station comprises:
a receiver to receive said control message;
control logic to connect to said receiver, said control logic to send said response message in response to said control message; and
a transmitter to connect to said control logic, said transmitter to include a pilot tone generator, said pilot tone generator to generate said pilot tones for said set of frequency bands in response to said control message.

53. The system of claim 50, wherein said control message includes an identifier for said subscriber station, an identifier for a subscriber station antenna, said set of pilot tones, and a data region for a response message.

54. The system of claim 50, wherein said control message includes an extended uplink interval usage code, a connection identifier, an antenna identifier, a preamble location, a symbol number, a pilot set number, a preamble period, a pilot transmission power scheme, and a response message allocation.

55. The system of claim 50, wherein said response message includes a management message type, a symbol number, a pilot set number, a preamble period, an antenna number, a subcarrier index, and a subcarrier signal-to-interference-plus-noise ratio.

56. The system of claim 50, wherein said orthogonal frequency division multiple access air interface is defined by an 802.16 Specification.
